(19) United States
(12) Patent Application Publication
(10) Pub. No.: US 2023/0135335 A1
(43) Pub. Date: May 4, 2023

(54) TEXT GENERATION APPARATUS AND MACHINE LEARNING METHOD

(71) Applicant: FUJITSU LIMITED, Kawasaki-shi (JP)

(72) Inventor: Takuya MAKINO, Kawasaki (JP)

(73) Assignee: FUJITSU LIMITED, Kawasaki-shi (JP)

(21) Appl. No.: 18/091,400

(22) Filed: Dec. 30, 2022

Related U.S. Application Data
(63) Continuation of application No. PCT/JP20/29666, filed on Aug. 3, 2020.

(51) Int. Cl. G06F 40/56; G06V 30/19; G06F 40/242

(52) U.S. Cl. CPC G06F 40/56; G06V 30/19093; G06F 40/242

(57) ABSTRACT

A text generation apparatus receives a first text. The text generation apparatus specifies a first position in the first text of a word that is identical to a first word whose use in a second text to be generated based on the first text has been determined. The text generation apparatus selects a second word from a plurality of words included in the first text based on positional relationships between each of the plurality of words and the first position. The text generation apparatus generates the second text including the second word.

### CROSS-REFERENCE TO RELATED APPLICATION

This application is a continuation application of International Application PCT/JP2020/029666 filed on Aug. 3, 2020 which designated the U.S., the entire contents of which are incorporated herein by reference.

### FIELD

The embodiments discussed herein relate to a text generation apparatus and a machine learning method.

### BACKGROUND

One technique in natural language processing is text generation, where a new text is generated from a given text. The generated text may be written in the same natural language as the original text. The generated text may also be a summary of the original text.

Text generation may use a model generated by machine learning. As one example, a neural network model that generates a summary of an original text has been proposed. The proposed model calculates an attention probability for each of a plurality of words from a vector containing context information for each of a plurality of words included in the original text and a vector containing context information for an output word most recently selected for use in a summary. Here, the expression “attention” refers to a technique in machine learning that determines which parts of input data are to be emphasized. As one example, the attention probability is a probability indicating a degree of focus when selecting the next output word. Attention probabilities are calculated with consideration to the relevance between vectors for a given word and a previous output word. The proposed model selects the next output word to be used in the summary based on attention probabilities. The proposed model iteratively selects one output word and computes the attention probability for each word in the original text to generate the summary. See for example, the following reference.

Abigail See, Peter J. Liu and Christopher D. Manning, “Get To The Point: Summarization with Pointer-Generator Networks”, Proc. of the 55th Annual Meeting of the Association for Computational Linguistics (ACL 2017), pp. 1073-1083, Jul. 30, 2017.

### SUMMARY

According to an aspect, there is provided a non-transitory computer-readable recording medium storing therein a computer program that causes a computer to execute a process including: receiving a first text; specifying a first position in the first text of a word that is identical to a first word whose use in a second text to be generated based on the first text has been determined; selecting a second word from a plurality of words included in the first text based on positional relationships between each of the plurality of words and the first position; and generating the second text including the second word.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts a text generation apparatus according to a first embodiment;

FIG. 2 depicts a machine learning apparatus according to a second embodiment;

FIG. 3 depicts example hardware of a machine learning apparatus according to a third embodiment;

FIG. 4 depicts a first example data flow for generating a summary;

FIG. 5 depicts examples of an input text and a summary text;

FIG. 6 depicts an example calculation of a position vector;

FIG. 7 depicts an example calculation of attention probabilities that uses position vectors;

FIG. 8 depicts a second example data flow for generating a summary;

FIG. 9 is a block diagram depicting example functions of a machine learning apparatus;

FIG. 10 is a flowchart depicting an example procedure for model generation;

FIG. 11 is (part two of) a flowchart depicting an example procedure of model generation;

FIG. 12 is a flowchart depicting an example procedure for summary generation; and

FIG. 13 is (part two of) a flowchart depicting an example procedure for summary generation.

### DESCRIPTION OF EMBODIMENTS

With the text generation technique described above, after one word has been selected from the original text, it is possible for the word selected next to have strong relevance between vectors with the selected word but be located far from the selected word. As a result, the text generation technique described above has a problem in that words present at distant locations in the original text end up being gathered together, resulting in the generation of text that has a different meaning from the original text. As one example, the text generation technique described above may generate a summary containing false information not present in the original text.

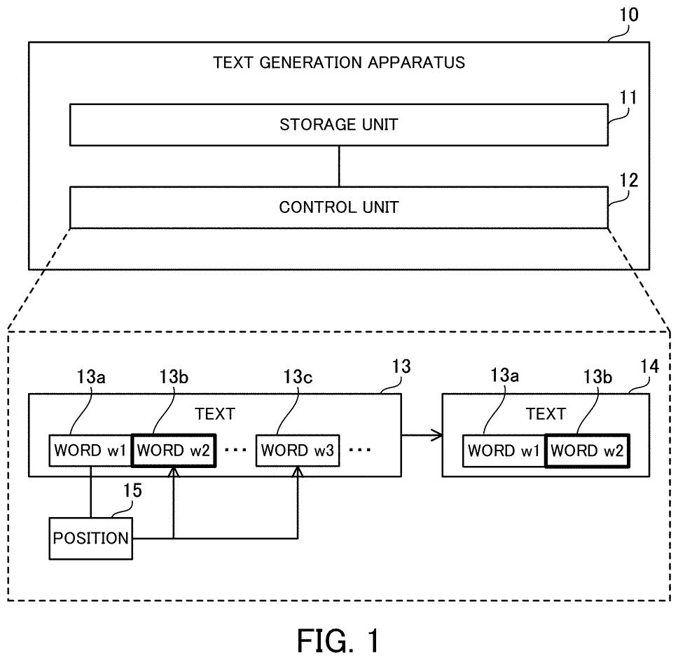

Several embodiments will now be described below with reference to the accompanying drawings. First, a first embodiment will be described. FIG. 1 depicts a text generation apparatus according to the first embodiment. A text generation apparatus 10 according to the first embodiment generates a new text from a given text.

The generated text is written in the same natural language as the original text. The text generation apparatus 10 generates the new text using some out of a plurality of words included in the original text. As one example, the generated text is a summary of the original text. The text generation apparatus 10 may generate text using a trained model that has been generated by machine learning. The text generation apparatus 10 may be a client apparatus or a server apparatus. The text generation apparatus 10 may be referred to as a “computer” or an “information processing apparatus”.

The text generation apparatus 10 includes a storage unit 11 and a control unit 12. The storage unit 11 may be a volatile semiconductor memory, such as random access memory (RAM). The storage unit 11 may alternatively be non-volatile storage, such as a hard disk drive (HDD) or flash memory. As one example, the control unit 12 is a processor, such as a central processing unit (CPU), a graphics processing unit (GPU), or a digital signal processor (DSP). The control unit 12 may include application-specific electronic circuitry, such as an application specific integrated circuit (ASIC) or a field programmable gate array (FPGA). The processor executes a program stored in a memory, such as RAM (which may be the storage unit 11). A group of a plurality of processors is referred to sometimes as a “multiprocessor” or simply as a “processor.”

The storage unit 11 stores a text 13. The text 13 is written in at least one natural language, such as English or Japanese. The text 13 includes a plurality of words. The plurality of words are arranged in a series. A relative positional relationship is defined between any two words out of the plurality of words. As examples, the relative positional relationship may be the context (or order) of the two words or the distance between the two words. As one example, the distance is an integer obtained by adding one to the number of words present between the two words.

As an example, the text 13 includes words 13a, 13b, and 13c. The word 13b is close to the word 13a. As one example, the word 13b is the word that follows immediately after the word 13a. In this case, the distance between the word 13a and the word 13b is one. The word 13c is far from the word 13a. As one example, the word 13c is a word positioned later in the text than the word 13a and is further away than the word 13b. As one example, the distance between the word 13a and the word 13c is 40.

The control unit 12 generates a text 14 based on the text 13. As one example, the text 14 is a summary of the text 13. Here, assume that the control unit 12 has decided to use the word 13a in the text 14. The control unit 12 then searches the text 13 for the same word as the word 13a and specifies a position 15 of the found word in the text 13. The control unit 12 specifies the relative positional relationships between the specified position 15 and each of the plurality of words included in the text 13. The control unit 12 selects the word 13b out of the plurality of words included in the text 13 based on a specified positional relationship.

By doing so, the control unit 12 selects the word 13b immediately following the word 13a as a word to be used in the text 14. The text 14 generated by the control unit 12 includes the word 13a and the word 13b positioned immediately following the word 13a.

When selecting the next word, as one example, the control unit 12 calculates an attention probability of each of a plurality of words included in the text 13 and selects the word with the highest attention probability. The control unit 12 may calculate the attention probability of each word based on the relevance between vectors of a given word and the word 13a selected immediately before. In order to reflect the relevance between the vectors, the control unit 12 may use a vector representing each word included in the text 13 and a vector representing the word 13a selected immediately before to calculate the attention probability of each word. The control unit 12 may calculate a vector containing context information for words using a trained neural network.

When doing so, as one example, the control unit 12 calculates the attention probability of each word included in the text 13 based on the positional relationship of each word with the position 15. The control unit 12 may increase the attention probabilities of words closer to the position 15 and may decrease the attention probabilities of words farther from the position 15. The control unit 12 may decrease the attention probability of words that come before the position 15 and may increase the attention probability of words that come after the position 15. The control unit 12 may calculate a position vector obtained by vectorizing numerical values representing distances from the position 15, and calculate the attention probabilities using this position vector.

With the text generation apparatus 10 according to the first embodiment, the position 15 in the text 13 of an identical word to the word 13a that has been determined for use in the text 14 is specified. Based on the positional relationships between each of the plurality of words included in the text 13 and the position 15, the word 13b is then selected and the text 14 including the word 13b is generated.

By doing so, when selecting the next word from the text 13 after selecting the word 13a, the text generation apparatus 10 selects the next word with consideration to positional relationships with the word 13a. Accordingly, the text generation apparatus 10 is able to reduce the risk of the text 14 being generated by unnaturally gathering together words at distant positions in the text 13. This means that the text generation apparatus 10 is able to reduce the risk of the generated text 14 having a different meaning from the text 13. As one example, the text generation apparatus 10 is able to reduce the likelihood of a summary including false information that is not present in the text 13 being generated from the text 13. In this way, changes in meaning when generating the text 14 from the text 13 are suppressed.

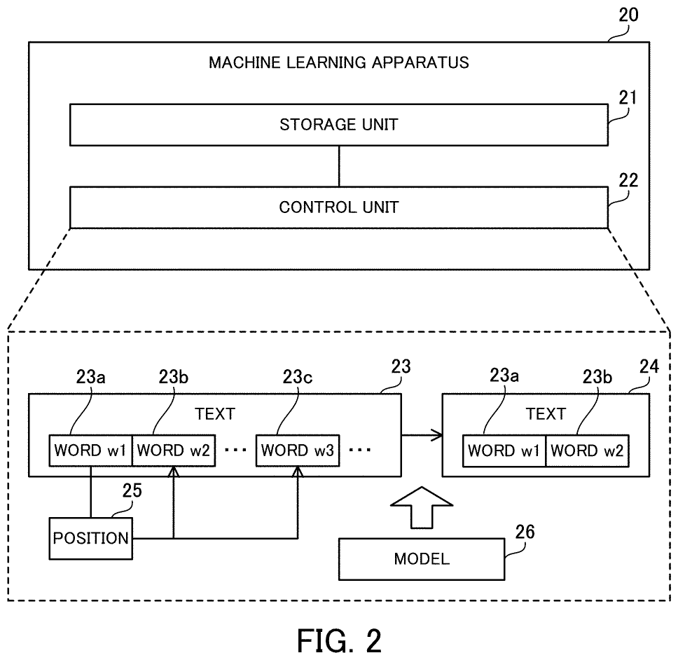

Next, a second embodiment will be described. FIG. 2 depicts a machine learning apparatus according to the second embodiment. A machine learning apparatus 20 according to the second embodiment uses machine learning to generate a model for generating a new text from a given text. The model generated by the machine learning apparatus 20 may be used by the text generation apparatus 10 according to the first embodiment.

The machine learning apparatus 20 may be a client apparatus or a server apparatus. The machine learning apparatus 20 may be referred to as a “computer” or an “information processing apparatus”. The machine learning apparatus 20 has a storage unit 21 and a control unit 22. The storage unit 21 may be volatile semiconductor memory such as RAM. The storage unit 21 may be non-volatile storage such as an HDD or flash memory. As examples, the control unit 22 is a processor such as a CPU, a GPU, or a DSP. The control unit 22 may include application-specific electronic circuitry, such as an ASIC or an FPGA. The processor executes a program stored in a memory such as RAM (which may be the storage unit 21).

The storage unit 21 stores texts 23 and 24. The texts 23 and 24 are training data used in machine learning. The text 23 is input data corresponding to an input into the model. The text 24 is teacher data corresponding to the output from the model. The texts 23 and 24 are written in the same natural language. As one example, the text 24 is a summary of the text 23. The text 24 may be created manually based on the text 23.

The text 23 includes a plurality of words. As one example, the text 23 includes words 23a, 23b, and 23c. The word 23b is close to the word 23a. As one example, the word 23b is the word immediately following the word 23a. The word 23c is far from the word 23a. As one example, the word 23c is positioned later in the text than the word 23a and is further away than the word 23b. The text 24 includes a plurality of words. The text 24 includes some out of the plurality of words included in the text 23. As one example, the text 24 includes the words 23a and 23b. In the text 24, the word 23b is the word positioned immediately following the word 23a.

The control unit 22 performs machine learning using the texts 23 and 24 to generate the model 26. The model 26 may be a neural network. The control unit 22 searches the text 23 for the same word as the word 23a included in the text 24, and specifies a position 25 of the found word in the text 23 based on the attention probabilities from the immediately preceding calculation. The control unit 22 identifies relative positional relationships between the identified position 25 and each of the plurality of words included in the text 23. The control unit 22 calculates the attention probability of the word 23b included in the text 24 being selected out of the plurality of words included in the text 23 based on the specified positional relationships.

The control unit 22 generates the model 26, which is capable of generating the text 24 from the text 23, based on the calculated attention probabilities. As one example, the control unit 22 calculates the attention probability of each word included in the text 23 based on the relevance between vectors of the word 23a and each word. In order to reflect the relevance between the vectors, the control unit 22 may calculate the attention probability of each word using a vector representing context information of each word included in the text 23 and a vector representing context information of the word 23a. The control unit 22 may calculate the vectors using a trained model. The trained model may be a neural network.

When doing so, as one example, the control unit 22 calculates the attention probability of each word included in the text 23 based on the positional relationship with the position 25. The control unit 22 may increase the attention probability of words in keeping with proximity to the position 25 and may decrease the attention probability of words in keeping with distance from the position 25. Also, the control unit 22 may decrease the attention probability of words that come before the position 25 and may increase the attention probability of words that come after the position 25. The control unit 22 may calculate a position vector obtained by vectorizing numerical values representing the distances from the position 25 and calculate the attention probabilities using this position vector.

When generating the model 26, as one example, the control unit 22 updates the values of parameters included in the model 26 based on a condition of maximizing the generation probability of the word 23b, which is the correct word. As one example, the generation probability of the word 23b referred to here is the final probability of the word 23b being selected as the next word. The parameters may be weights of a neural network. The control unit 22 may update the values of the parameters by error backpropagation. By doing so, when the text 23 is inputted, the model 26 selects the word 23a from the text 23 and selects the word 23b from the text 23 following the word 23a.

With the machine learning apparatus 20 according to the second embodiment, the position 25 in the text 23 of the same word as the word 23a included in the text 24 is specified based on the attention probabilities from the immediately preceding calculation. After this, based on the positional relationship between each of the plurality of words included in the text 23 and the position 25, the attention probability of the next word 23b being selected is calculated and the model 26 is generated based on the attention probability of the word 23b.

As a result, when the model 26 generated by the machine learning apparatus 20 selects one word from the input text and then selects the next word from the input text, the model 26 selects the next word with consideration to the positional relationship with the previous word. Accordingly, the model 26 is able to reduce the risk of the output text being generated by unnaturally gathering together words at distant positions in the input text. This means that the model 26 is able to reduce the likelihood that the output text will have a different meaning from the input text. As one example, the model 26 is able to reduce the likelihood of generating, from the input text, a summary including false information not present in the input text. In this way, changes in meaning when generating output text from input text using the model 26 are suppressed.

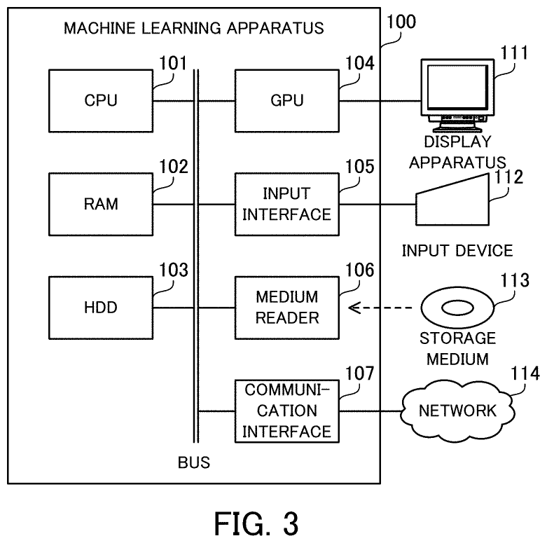

Next, a third embodiment will be described. FIG. 3 depicts example hardware of a machine learning apparatus according to the third embodiment. A machine learning apparatus 100 according to the third embodiment uses machine learning to generate a model for generating a summary text from an input text. The machine learning apparatus 100 uses the generated model to generate a summary text from the input text. The machine learning apparatus 100 may be a client apparatus or may be a server apparatus. The machine learning apparatus 100 is sometimes referred to as a “computer” or an “information processing apparatus”. Note that although the machine learning apparatus 100 both generates a model and uses the model in the third embodiment, it is also possible for separate apparatuses to generate the model and use the model.

The machine learning apparatus 100 includes a CPU 101, a RAM 102, an HDD 103, a GPU 104, an input interface 105, a medium reader 106, and a communication interface 107. These units of the machine learning apparatus 100 are connected to a bus. The machine learning apparatus 100 corresponds to the text generation apparatus 10 according to the first embodiment and the machine learning apparatus 20 according to the second embodiment. The CPU 101 corresponds to the control unit 12 in the first embodiment and the control unit 22 in the second embodiment. The RAM 102 or the HDD 103 corresponds to the storage unit 11 in the first embodiment and the storage unit 21 in the second embodiment.

The CPU 101 is a processor that executes instructions of a program. The CPU 101 loads at least part of a program and data stored in the HDD 103 into the RAM 102 and executes the program. The CPU 101 may include a plurality of processor cores, and the machine learning apparatus 100 may include a plurality of processors. A group of a plurality of processors is sometimes referred to as a “multiprocessor” or simply as a “processor”.

The RAM 102 is a volatile semiconductor memory that temporarily stores programs executed by the CPU 101 and data used in computation by the CPU 101. The machine learning apparatus 100 may include a type of memory aside from RAM, or may be equipped with a plurality of memories.

The HDD 103 is non-volatile storage that stores software programs such as an operating system (OS), middleware, and application software, as well as data. The machine learning apparatus 100 may be equipped with other types of storage, such as flash memory and a solid state drive (SSD), and may include a plurality of storage devices.

The GPU 104 outputs an image to a display apparatus 111 connected to the machine learning apparatus 100 in accordance with instructions from the CPU 101. As the display apparatus 111, a freely chosen type of display apparatus may be used, such as a cathode ray tube (CRT) display, a liquid crystal display (LCD), an organic electro-luminescence (EL) display, or a projector. It is also possible to connect an output device aside from the display apparatus 111, such as a printer, to the machine learning apparatus 100.

The input interface 105 receives an input signal from an input device 112 connected to the machine learning apparatus 100. As the input device 112, it is possible to use any freely chosen type of input device, such as a mouse, a touch panel, a touch pad, or a keyboard. A plurality of types of input device may be connected to the machine learning apparatus 100.

The medium reader 106 is a reader apparatus that reads programs and data recorded on a recording medium 113. It is possible to use any freely chosen type of recording medium as the recording medium 113, including a magnetic disk such as a flexible disk (FD) or HDD, an optical disc such as a compact disc (CD) or a digital versatile disc (DVD), and a semiconductor memory. As one example, the medium reader 106 copies programs and data read from the recording medium 113 to another recording medium, such as the RAM 102 or the HDD 103. The read program is executed by the CPU 101, for example. Note that the recording medium 113 may be a portable recording medium, and may be used for distribution of programs and data. The recording medium 113 and the HDD 103 may be referred to as “computer-readable recording media”.

The communication interface 107 is connected to a network 114 and communicates with other information processing apparatuses via the network 114. The communication interface 107 may be a wired communication interface connected to a wired communication apparatus, such as a switch or a router, or a wireless communication interface connected to a wireless communication apparatus, such as a base station or an access point.

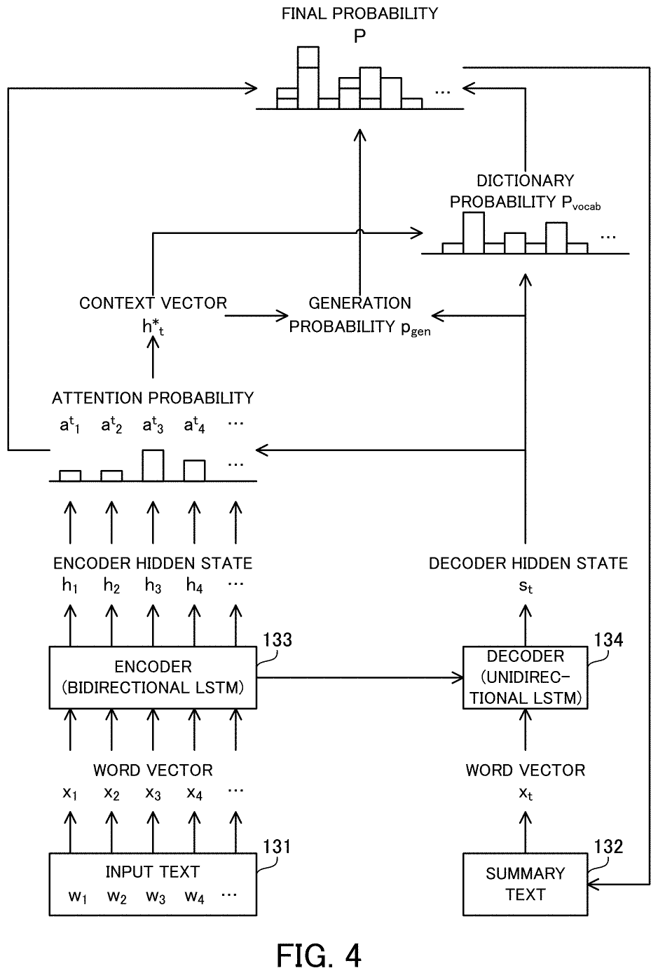

Next, a summary generation model will be described. FIG. 4 depicts a first example data flow for generating a summary. The machine learning apparatus 100 receives an input text 131. The input text 131 includes one or more sentences written in a specified natural language, such as English or Japanese. The text is sometimes referred to as a “document”. The input text 131 includes words w₁, w₂, w₃, w₄, . . . . The machine learning apparatus 100 divides the sentences included in the input text 131 into words w₁, w₂, w₃, w₄, . . . using a natural language analysis technique, such as morphological analysis.

Words are sometimes referred to as “tokens”. A word is a character string that has a linguistic meaning. Words include a start tag indicating the start of a text and an end tag indicating the end of the text. Note that the “words” in the third embodiment may be units that are smaller than a linguistic word.

The machine learning apparatus 100 converts the words w₁, w₂, w₃, w₄, . . . included in the input text 131 into word vectors x₁, x₂, x₃, x₄, . . . . One word vector is calculated from one word. A word vector is a distributed representation vector. As one example, a word vector is a numerical sequence with a number of dimensions, such as 300 dimensions. The machine learning apparatus 100 calculates a vector representing context information of a word using a trained neural network. As one example, this neural network is generated by the method described below.

A neural network that includes an input layer, an output layer, and an intermediate layer between the input and output layers is provided. The input layer includes one node for each word that may appear in the text. The output layer includes one node for each word that may appear in the text. A given word and one or more peripheral words before or after the given word are extracted from a sample of text. The input data is a one-hot encoded vector where the elements corresponding to the given word are “1” and elements corresponding to other words are “0”. The teacher data is a vector in which elements corresponding to peripheral words are “1” and elements corresponding to other words are “0”. Input data is assigned to the input layer, an error is calculated between the output data of the output layer and the teacher data, and the weights of edges are updated by error backpropagation based on a condition of reducing the error.

By doing so, a neural network for distributed representation is generated. A feature vector listing numerical values calculated in the intermediate layer when a one-hot encoded vector of a given word was inputted is a distributed expression word vector of that word. Since there is a high likelihood of similar peripheral words appearing in the periphery of words with similar meanings, words with similar meanings are often assigned word vectors that are similar.

The machine learning apparatus 100 inputs word vectors x₁, x₂, x₃, x₄, . . . into an encoder 133. The encoder 133 outputs encoder hidden states h₁, h₂, h₃, h₄, . . . . The encoder hidden states are numeric vectors with the same dimensionality as the word vectors. One encoder hidden state is calculated for one word. The encoder 133 is a bi-directional long short term memory (LSTM). An LSTM is a neural network whose internal state is held. Since the internal state is held, when a plurality of input vectors are consecutively inputted into an LSTM, the output vector corresponding to a given input vector will depend not only on that input vector but also on previous input vectors.

A bidirectional LSTM includes a forward LSTM into which a plurality of input vectors are inputted in the forward direction, and a backward LSTM into which a plurality of input vectors are inputted in the reverse direction. Accordingly, word vectors are inputted into the forward direction LSTM included in the encoder 133 in the order “x₁, x₂, x₃, x₄, . . . .” In addition, word vectors are inputted in the order “ . . . , x₄, x₃, x₂, x₁” into the backward LSTM included in the encoder 133. The bidirectional LSTM is capable of expressing relevance between a given word and words that come after the given word. The bidirectional LSTM combines the output vector of the forward LSTM and the output vector of the backward LSTM corresponding to the same word to calculate a final output vector for that word. Edge weights included in the encoder 133 are parameters whose values are determined through machine learning.

The machine learning apparatus 100 also prepares a summary text 132. The summary text 132 when model generation is performed is a correct summary text corresponding to the input text 131. The correct summary text is teacher data that is created manually. The correct summary text includes a start tag at the start and an end tag at the end. On the other hand, the summary text 132 when summary generation is performed is generated from the input text 131 via the model. The generated summary text is first initialized so as to include only the start tag. The summary text 132 is written in the same natural language as the input text 131. The summary text 132 may include some out of the plurality of words included in the input text 131.

The machine learning apparatus 100 selects one word included in the summary text 132 as an output word wt at time t. The output word wt may appear in the input text 131 or there may be no output word wt appearing in the input text 131. When generating a model, the machine learning apparatus 100 selects a word following the previously selected word. The first word to be selected is the start tag. On the other hand, when generating a summary, the machine learning apparatus 100 selects a word that was added to the summary text 132 immediately previously.

The machine learning apparatus 100 converts the output word wt to a word vector xₜ using the trained neural network described earlier. The machine learning apparatus 100 inputs the word vector xₜ into a decoder 134. The decoder 134 calculates a decoder hidden state sₜ at time t based on the output of the encoder 133 and the word vector xₜ. A decoder hidden state is a numeric vector with the same dimensionality as a word vector.

The decoder 134 is a unidirectional LSTM. The decoder 134 includes a forward LSTM but does not include a backward LSTM. Accordingly, word vectors of the words included in the summary text 132 are inputted into the decoder 134 one by one in order from the word at the start. While time is advancing so that time t=1, 2, 3, . . . , the internal state of the forward LSTM is not initialized. The edge weights included in the decoder 134 are parameters whose values are determined through machine learning.

At time t, the machine learning apparatus 100 combines the encoder hidden states h₁, h₂, h₃, h₄, . . . and the decoder hidden state sₜ to calculate attention probabilities a^{t}₁, a^{t}₂, a^{t}₃, a^{t}₄, . . . . One attention probability is calculated for one word in the input text 131. The attention probability is a real number representing a probability that is at least 0 but no greater than 1.

The attention probability represents the importance of each word included in the input text 131 when estimating the next output word. The machine learning apparatus 100 calculates the attention probability using the word vector of the previous output word. This means that the attention probability of a word reflects the relevance to the previous output word. Words with strong relevance to the previous output word are likely to have a high attention probability. On the other hand, the attention probability of a word that has weak relevance to the previous output word is likely to be low. The attention probability is sometimes referred to as the “copy probability”. The copy probability is the probability that a word will be copied from the input text 131 into the summary text 132.

In a first data flow example, the attention probability is calculated according to Expression (1). In Expression (1), a^{t}ᵢ is the attention probability of a word wᵢ, and hᵢ is the encoder hidden state of the word wᵢ. Here, “softmax” is a softmax function for normalizing vectors. Wₕ and Wₛ are coefficient matrices, and v and bₐₜₜₙ are coefficient vectors. Accordingly, the attention probability of the word wᵢ at time t is calculated by a linear combination of the encoder hidden state of the word wᵢ and the decoder hidden state at time t. The coefficient matrices Wₕ and Wₛ and the coefficient vectors v and bₐₜₜₙ are parameters whose values are determined through machine learning.

aᵢ^{t}=softmax(v^{T} tan h(Wₕhᵢ+Wₛsₜ+bₐₜₜₙ)) (1)

The machine learning apparatus 100 weights the encoder hidden states h₁, h₂, h₃, h₄, . . . using the attention probabilities a^{t}₁, a^{t}₂, a^{t}₃, a^{t}₄, . . . and sum the weighted values to calculate the context vector h*ₜ. The context vector h*ₜ is calculated according to Expression (2). A context vector is a numeric vector with the same dimensionality as a word vector. The context vector compresses and expresses important information for estimating the next output word out of the information included in the encoder hidden states h₁, h₂, h₃, h₄, . . . .

$${h}_{t}^{*} = {\sum }_{i} {a}_{i}^{t} {h}_{i} \qquad ( 2 )$$

The machine learning apparatus 100 calculates a dictionary probability P_{vocab} of each word written in a dictionary based on the context vector h*ₜ and the decoder hidden state sₜ. A dictionary probability is a real number expressing a probability that is at least 0 but no greater than 1. The dictionary probability represents the importance of each word listed in a dictionary when estimating the next output word. However, the input text 131 may include words that are not listed in the dictionary. Words that are similar to the words with high attention probabilities are likely to have high dictionary probabilities. The dictionary probability P_{vocab} is calculated according to Expression (3). In Expression (3), V and V′ are coefficient matrices and b and b′ are coefficient vectors. The coefficient matrices V and V′ and the coefficient vectors b and b′ are parameters whose values are determined through machine learning.

P_{vocab}=softmax(V′(V[sₜ,hₜ*]+b)+b′) (3)

The machine learning apparatus 100 also calculates a generation probability p_{gen} based on the context vector h*ₜ, the decoder hidden state sₜ, and the word vector xₜ. The generation probability is a real number expressing a probability of at least 0 but no greater than 1. The generation probability represents a ratio between the importance of words included in the input text 131 and the importance of words listed in the dictionary. The generation probability serves as a switch between a method that selects the next output word from the input text 131 and a method that selects the next word from the dictionary. The generation probability p_{gen} is calculated according to Expression (4). In Expression (4), σ is a sigmoid function for normalizing the generation probability. wₕ*, wₛ, and wₓ are coefficient vectors, and bₚₜᵣ is a constant. Accordingly, the generation probability at time t is calculated by a linear combination of the context vector h*ₜ the decoder hidden state sₜ, and the word vector xₜ. The coefficient vectors wₕ*, wₛ, and wₓ and the constant bₚₜᵣ are parameters whose values are determined through machine learning.

p_{gen}=σ(w_{h*}^{T}hₜ*+wₛ^{T}sₜ+wₓ^{T}xₜ+bₚₜᵣ) (4)

The machine learning apparatus 100 weights the attention probabilities a^{t}₁, a^{t}₂, a^{t}₃, a^{t}₄ . . . and the dictionary probability P_{vocab} according to the generation probability p_{gen} and sums the weighted values to calculate the final probability P of each word. The final probability is a real number expressing a probability that is at least 0 but no greater than 1. The final probability of a given word represents the probability of that word being selected as the next output word. Here, a “word set” is a set produced by combining words included in the input text 131 and words listed in the dictionary. The final probability P of a word w is calculated according to Expression (5). The machine learning apparatus 100 multiplies the dictionary probability P_{vocab} of a word w by p_{gen}, multiplies the attention probability a^{t}ᵢ of the word w by (1−p_{gen}), and calculates the sum of both values as the final probability P of the word w.

$$P ( w ) = {p}_{gen} {P}_{vocab} ( w ) + ( 1 - {p}_{gen} ) {\sum }_{{w}_{i} = w} {a}_{i}^{t} \qquad ( 5 )$$

Here, when a given word is listed in the dictionary but is not included in the input text 131, the machine learning apparatus 100 regards the attention probability of that word as zero. Likewise, when a given word is included in the input text 131 but is not listed in the dictionary, the dictionary probability of that word is regarded as zero. Also, the same word may appear two or more times in the input text 131. In that case, as depicted in Expression (5), the machine learning apparatus 100 sums two or more attention probabilities corresponding to the same word and multiplies the result by (1−p_{gen}).

When generating a summary, the machine learning apparatus 100 selects the word with the highest final probability P from the word set as an output word, and adds the selected output word to the end of the summary text 132. The machine learning apparatus 100 inputs a word vector corresponding to the added output word into the decoder 134 and repeats the processing described above. However, when the selected output word is an end tag, the machine learning apparatus 100 ends the generation of the summary text 132.

When generating the model, the machine learning apparatus 100 reads the correct output word from the summary text 132 and obtains the final probability P calculated for the correct output word. The machine learning apparatus 100 calculates an error based on the final probability P of the correct output word. When doing so, the lower the final probability P, the larger the error calculated by the machine learning apparatus 100, and the higher the final probability P, the smaller the calculated error. The machine learning apparatus 100 inputs word vectors corresponding to the correct output words instead of the words with the highest final probabilities P into the decoder 134 and repeats the processing described above. The machine learning apparatus 100 updates the values of the adjustable parameters described earlier to optimize the model based on a condition of minimizing the average error.

The average error “loss” is calculated according to Expression (6) for example. In Expression (6), P(w*ₜ) is the final probability of the correct word, and T is the number of words included in the summary text 132. The machine learning apparatus 100 calculates the average of the negative logarithms of the final probability P(w*ₜ), that is, the average of the logarithms of the reciprocals of the final probabilities P(w*ₜ) as the average error “loss”.

$$loss = \frac{1}{T} {\sum }_{t} ( - log P ( {w}_{t}^{*} ) ) \qquad ( 6 )$$

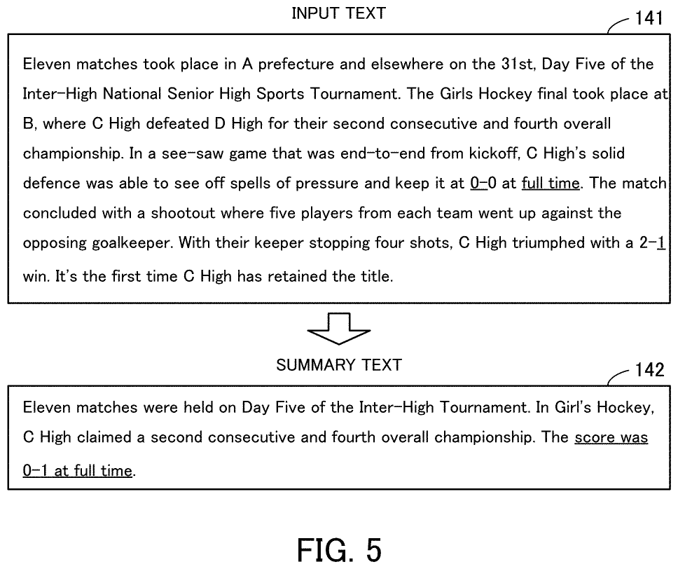

Next, a problem that may occur when a summary text is generated using the model in FIG. 4 will be described. FIG. 5 depicts examples of the input text and the summary text. A summary text 142 is generated from an input text 141 using the model in FIG. 4.

The input text 141 includes the expressions “0-0 at full time” and “2-1 win”. In contrast, the summary text 142 includes the expression “0-1 at full time”. The above expression included in the summary text 142 does not exist in the input text 141. This means that the summary text 142 is an inappropriate summary including false information. The summary text 142 including false information is generated for the reason described below.

The model in FIG. 4 searches the entire input text 141 for words that have a strong semantic relevance for previous output words. This means that when “0-” is used in the summary text 142, in addition to the second “0” of “0-0 at full time”, the “1” in the expression “2-1 win” also becomes a candidate for the next output word. This results in the possibility of “1” in “2-1 win” being used. In this way, the model in FIG. 4 may gather words from the entire input text 141 to produce the summary text 142 that has a different meaning from the input text 141.

For this reason, the machine learning apparatus 100 generates an improved summary generation model, and uses this improved summary generation model to generate a summary text from an input text. The improved model operates so that after an output word has been selected from the input text, when selecting the next output word, the position of the output word in the input text is determined based on the attention probabilities from the immediately preceding calculation, and the attention probability of each word is calculated based on the positional relationship with the immediately previous output word. The attention probabilities calculated here tend to be higher for words that are closer to the immediately preceding output word, and tend to be lower for words farther from the immediately preceding output word. Accordingly, the final probabilities of words that are positionally close to the immediately preceding output word increase.

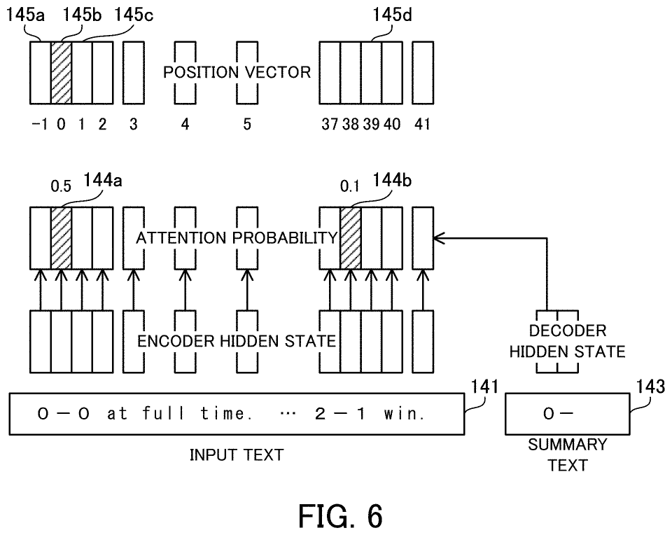

FIG. 6 depicts an example calculation of a position vector. The machine learning apparatus 100 receives the input text 141 and generates a summary text 143 from the input text 141. The input text 141 includes the character strings “0-0 at full time” and “2-1 win”. The machine learning apparatus 100 divides these character strings into the words “0”, “-”, “0”, “at”, “full”, “time”, “2”, “-”, “1”, and “win”. Assume that the machine learning apparatus 100 has selected “0” and then “-” as the output words.

When searching for the next output word after the output word “-”, the machine learning apparatus 100 acquires the attention probabilities calculated immediately previously. The attention probabilities from the immediately preceding calculation were calculated based on the encoder hidden states corresponding to the words “0”, “-”, “0”, “at”, “full”, “time”, “2”, “-”, “1”, and “win” and the decoder hidden state corresponding to the output word “0”. The machine learning apparatus 100 searches the input text 141 for the determined output word with priority from the end of the summary text 143. In the example in FIG. 6, a word that is identical to the output word “-” at the end of the summary text 143 is detected at two locations in the input text 141. When this final output word does not exist in the input text 141, the machine learning apparatus 100 repeatedly searches the input text 141 for one output word further back until a corresponding word is detected.

The machine learning apparatus 100 acquires the attention probabilities of the detected word(s). In the example in FIG. 6, the machine learning apparatus 100 acquires the attention probability 144a of “-” in “0-0 at full time” and the attention probability 144b of “-” in “2-1 win”. The attention probability 144a is 0.5 and the attention probability 144b is 0.1. The machine learning apparatus 100 specifies the position of the word with the highest attention probability at the immediately preceding time as a base point, and presumes that the word at the base point was copied from the input text 141 to the summary text 143. In the example in FIG. 6, since the attention probability 144a is the highest, the base point is “-” in “0-0 at full time”. Note that when only one word is found, the machine learning apparatus 100 does not need to acquire the attention probabilities.

The machine learning apparatus 100 calculates, for each word included in the input text 141, an index indicating the positional relationship with the specified base point. The index is an integer, which may be 0. The index represents the distance between words. The indices of words that come before the base point are negative integers, and the indices of words that come after the base point are positive integers. The index of the word at the base point is 0. The absolute value of the index of a word aside from the word at the base point is an integer obtained by adding 1 to the number of other words present between that word and the base point. In the example in FIG. 6, the indices of the words “0”, “-”, “0”, “at”, “full”, “time”, “2”, “-”, “1”, and “win” are −1, 0, 1, 2, 3, 4, 37, 38, 39, and 40.

The machine learning apparatus 100 converts the integer index into a position vector. A position vector is a numeric vector with the same dimensionality as a word vector. Position vectors corresponding to integers that are close are similar. The machine learning apparatus 100 calculates the position vectors using a trained neural network in the same way as the word vectors. This trained neural network may be generated with the same method as the trained neural network described earlier, for example, with the words limited to words that represent integers.

In the example of FIG. 6, machine learning apparatus 100 calculates position vectors 145a, 145b, and 145c corresponding to the indices=−1, 0, 1 for “0”, “-”, and “0” in “0-0 at full time”. In addition, the machine learning apparatus 100 calculates the position vector 145d corresponding to the index=39 for “1” in “2-1 win”.

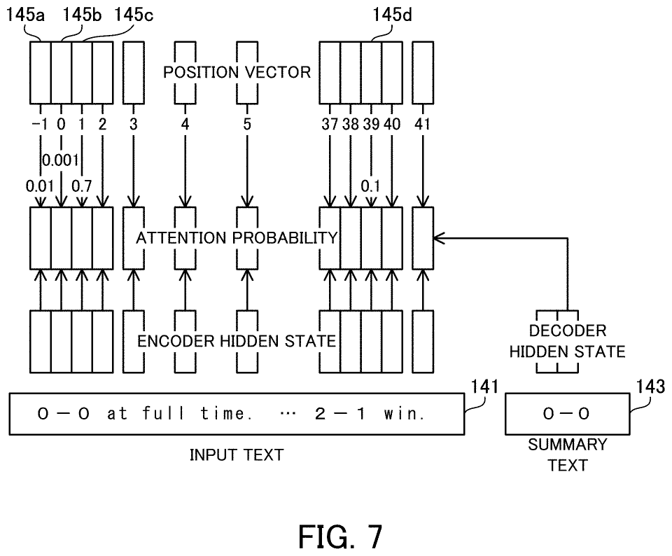

FIG. 7 depicts an example calculation of attention probabilities that uses position vectors. The machine learning apparatus 100 uses the decoder hidden state corresponding to the immediately preceding output word “-” to calculate attention probabilities corresponding to the words “0”, “-”, “0”, “at”, “full”, “time”, “2”, “-”, “1”, and “win”. When doing so, the machine learning apparatus 100 calculates the attention probabilities using the position vectors in addition to the encoder hidden states and decoder hidden state. A model is generated to have the following properties. Words with positive indices tend to have high attention probabilities, and words with negative indices tend to have low attention probabilities. Also, the attention probability of a word with an index that has a small absolute value tends to be high, and the attention probability of a word with an index that has a large absolute value tends to be low.

In the example in FIG. 7, the machine learning apparatus 100 uses the position vector 145a to calculate the attention probability of the first “0” in “0-0 at full time”. The machine learning apparatus 100 calculates the attention probability of “-” using the position vector 145b. The machine learning apparatus 100 calculates the attention probability of the second “0” using the position vector 145c. The machine learning apparatus 100 calculates the attention probability of the “1” in “2-1 win” using the position vector 145d. As a result, the attention probabilities of “0”, “-”, “0”, and “1” are calculated as 0.01, 0.001, 0.7 and 0.1.

Assuming that the dictionary probabilities of the above words do not differ greatly, the machine learning apparatus 100 will not select “1” in “2-1 win” but will instead select the second “0” in “0-0 at full time” as the next output word. The machine learning apparatus 100 then adds “0” to the summary text 143. In this way, when words for which there is strong relevance between vectors with a preceding output word are present at at least two locations in the input text 141, by calculating the attention probabilities using the position vectors, words that are close to the previously copied word become more likely to be selected.

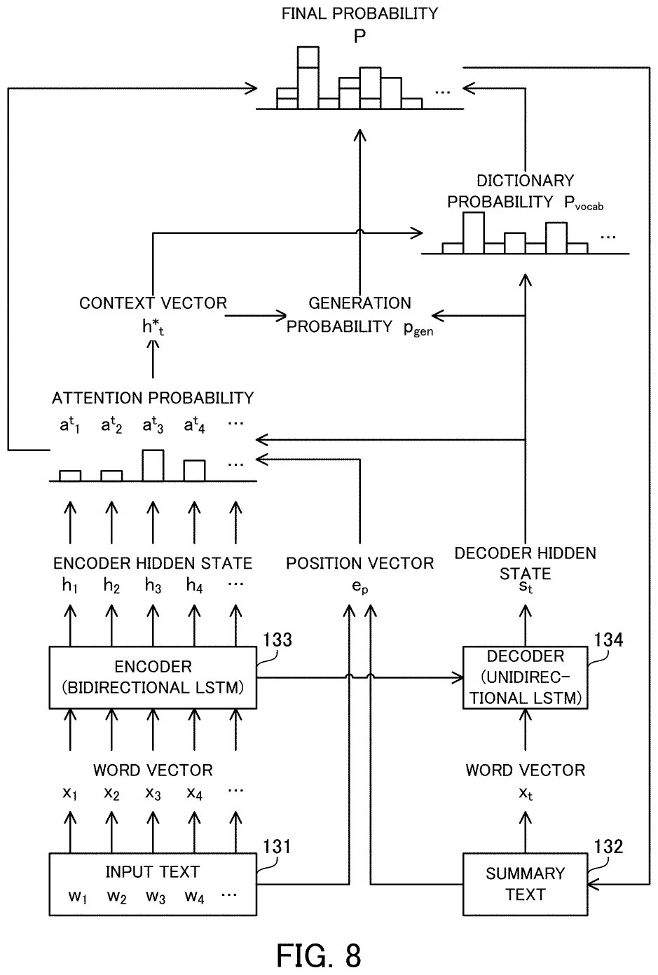

FIG. 8 depicts a second example data flow for generating a summary. The summary generation model in FIG. 8 is the same as the summary generation model in FIG. 4 except that position vectors are used to calculate the attention probabilities. The machine learning apparatus 100 searches the input text 131 for the most recent output word included in the summary text 132 based on the attention probabilities from the immediately preceding calculation, and specifies the position where the most recent output word was found as a base point. The machine learning apparatus 100 calculates indices representing the positional relationships between the base point and each word, and calculates a position vector eₚ for each word using a trained neural network.

The machine learning apparatus 100 combines the encoder hidden states h₁, h₂, h₃, h₄, . . . , the decoder hidden state sₜ, and the position vector eₚ to calculate the attention probabilities a^{t}₁, a^{t}₂, a^{t}₃, a^{t}₄, . . . . In the second dataflow example, the attention probabilities are calculated according to Expression (7). In Expression (7), Wₚ is a coefficient matrix. Accordingly, the attention probability of a word wᵢ at time t is calculated by a linear combination of the encoder hidden state of the word wᵢ, the decoder hidden state at time t, and the position vector at time t. The coefficient matrices Wₕ, Wₛ, and Wₚ and the coefficient vectors v and bₐₜₜₙ are parameters whose values are determined through machine learning.

aᵢ^{t}=softmax(v^{T} tan h(Wₕhᵢ+Wₛsₜ+Wₚeₚ+bₐₜₜₙ)) (7)

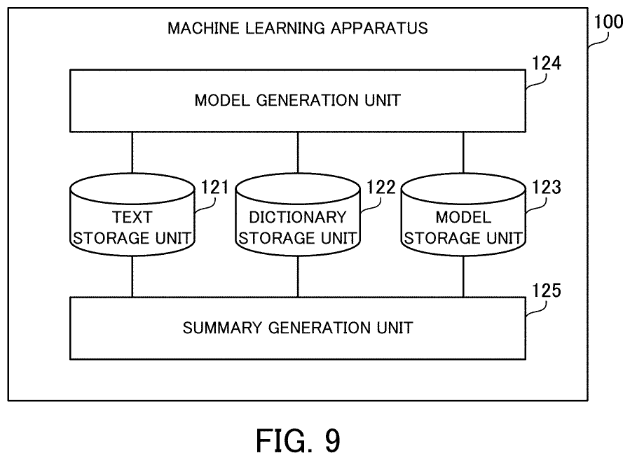

Next, the functions and processing procedure of the machine learning apparatus 100 will be described. FIG. 9 is a block diagram depicting example functions of the machine learning apparatus. The machine learning apparatus 100 includes a text storage unit 121, a dictionary storage unit 122, a model storage unit 123, a model generation unit 124, and a summary generation unit 125. The text storage unit 121, the dictionary storage unit 122, and the model storage unit 123 are realized using storage areas of the RAM 102 or the HDD 103, for example. The model generation unit 124 and the summary generation unit 125 are realized using programs, for example.

The text storage unit 121 stores an input text used as input data in machine learning and a summary text used as teacher data in the machine learning. The summary text is produced by the user as a correct summary corresponding to the input text. The text storage unit 121 also stores an input text to be used as input data when generating a summary text using the generated model.

The dictionary storage unit 122 stores dictionary data listing a plurality of words that may be used in a given natural language. The dictionary data does not have to include every word that may be included in an input text. In other words, the input text may include words that are not present in the dictionary data. The model storage unit 123 stores a summary generation model that has been generated by the model generation unit 124. The model storage unit 123 also stores a trained model for converting words into word vectors and a trained model for converting integers into position vectors.

The model generation unit 124 reads the input text and the summary text for machine learning from the text storage unit 121. The model generation unit 124 also reads dictionary data corresponding to the natural language used in the input text and the summary text from the dictionary storage unit 122. The model generation unit 124 generates a summary generation model that implements the data flow depicted in FIG. 8 and stores the generated summary generation model in the model storage unit 123. When doing so, the model generation unit 124 optimizes the various parameters described earlier by machine learning. The summary generation model that is generated includes the encoder 133 and the decoder 134.

The summary generation unit 125 reads an input text to be simplified from the text storage unit 121. The summary generation unit 125 also reads the dictionary data corresponding to the natural language used in the input text from the dictionary storage unit 122. The summary generation unit 125 also reads the summary generation model from the model storage unit 123. The summary generation unit 125 inputs the input text into the summary generation model to generate a summary text. The summary generation unit 125 stores the generated summary text in the text storage unit 121. The summary generation unit 125 also displays the generated summary text on the display apparatus 111. The summary generation unit 125 may transmit the generated summary text to another information processing apparatus, or may output the summary text to another output device, such as a printer.

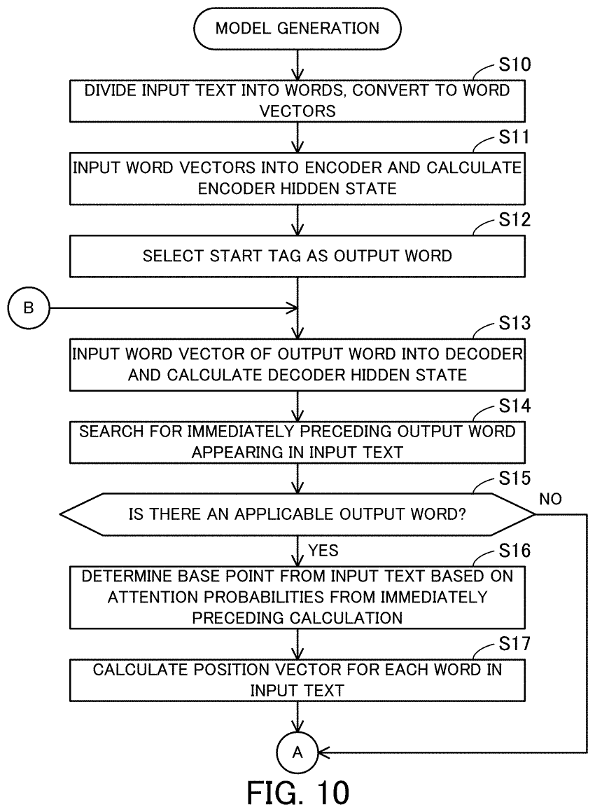

FIG. 10 is a flowchart depicting an example procedure for model generation. (S10) The model generation unit 124 divides the input text into a plurality of words. The model generation unit 124 uses a trained word model to convert the respective words produced by division into a distributed representation word vector xᵢ.

(S11) The model generation unit 124 inputs the word vector xᵢ into the encoder 133 to calculate the encoder hidden state hᵢ of each word. Note that the encoder 133 is a bi-directional LSTM. Accordingly, the encoder 133 includes an LSTM into which a plurality of word vectors are inputted in the forward direction and an LSTM into which a plurality of word vectors are inputted in the reverse direction.

(S12) The model generation unit 124 selects the start tag as an output word.

(S13) The model generation unit 124 uses a trained word model to convert the currently selected output word into a distributed representation word vector xₜ. The model generation unit 124 inputs the word vector xₜ into the decoder 134 to calculate the decoder hidden state sₜ.

(S14) The model generation unit 124 searches the input text for the immediately preceding output word, out of the output words included in the summary text. The immediately preceding output word is the currently selected output word or the previous output word. When at least two output words appear in the input text, the model generation unit 124 gives priority to the latter output word. The model generation unit 124 excludes the start tag from the search. This means that when the currently selected output word is the start tag, there is no output word that satisfies the search condition given above.

(S15) The model generation unit 124 determines whether there is an output word that meets the search condition of step S14 in the summary text. When there is an applicable output word, the processing proceeds to step S16, and when there is no applicable output word, the processing proceeds to step S18.

(S16) The model generation unit 124 determines a base point from the input text based on the attention probabilities a^{t}ᵢ from the immediately previous calculation. In more detail, the model generation unit 124 specifies a position where the output word that meets the search condition of step S14 appears. When the applicable output word appears at only one position, the model generation unit 124 determines that position as the base point. On the other hand, when the applicable output word appears at two or more positions, the model generation unit 124 determines the position of the word with the highest attention probability a^{t}ᵢ in the immediately previous calculation as the base point.

(S17) The model generation unit 124 calculates, for each word included in the input text, an index expressing a positional relationship with the base point of step S16. The model generation unit 124 converts these indices into a distributed representation position vector eₚ using a trained numerical model.

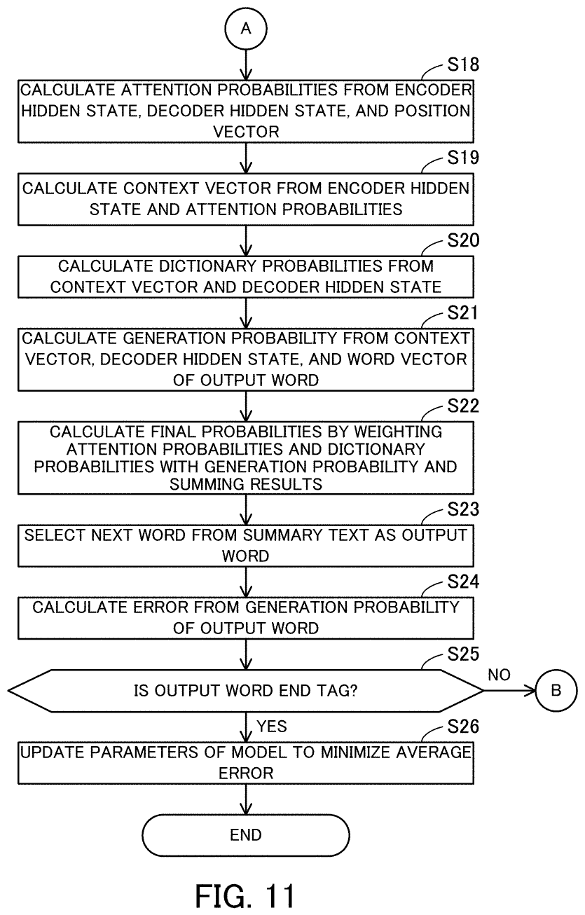

FIG. 11 is (part two of) a flowchart depicting an example procedure of model generation. (S18) The model generation unit 124 uses the encoder hidden state hᵢ, the decoder hidden state sₜ, and the position vector eₚ to calculate the attention probability a^{t}ᵢ of each word in the input text. Note that when the determination in step S15 is NO, the position vector eₚ is a zero vector.

(S19) The model generation unit 124 weights and sums the encoder hidden states hᵢ of the plurality of words included in the input text using the attention probabilities a^{t}ᵢ calculated in step S18 to calculate the context vector h*ₜ.

(S20) The model generation unit 124 calculates the dictionary probability P_{vocab} of each word included in the dictionary data from the context vector h*ₜ and the decoder hidden state sₜ.

(S21) The model generation unit 124 calculates the generation probability p_{gen} from the context vector h*ₜ, the decoder hidden state sₜ, and the word vector xₜ of the currently selected output word.

(S22) The model generation unit 124 weights the attention probabilities a^{t}ᵢ of the words included in the input text and the dictionary probabilities P_{vocab} of the words included in the dictionary data using the generation probability p_{gen} calculated in step S21, and sums the results to calculate the final probability P of each word. Here, the word set is a set produced by combining words included in the input text and words included in the dictionary data. The model generation unit 124 regards the dictionary probability P_{vocab} of a word included in the input text but not included in the dictionary data as zero. The attention probability a^{t}ᵢ of a word included in the dictionary data but not included in the input text is also regarded as zero. The model generation unit 124 multiplies the dictionary probability P_{vocab} by p_{gen} multiplies the attention probability a^{t}ᵢ by (1−p_{gen}), and sums the two values to calculate the final probability P.

(S23) The model generation unit 124 selects the word following the currently selected output word from the summary text as the next output word.

(S24) The model generation unit 124 extracts the final probability P of the output word selected in step S23, that is, the final probability P of the correct word, out of the final probabilities P calculated in step S22. The model generation unit 124 calculates an error from the final probability P of the correct word.

(S25) The model generation unit 124 determines whether the output word selected in step S23 is the end tag. When the selected output word is the end tag, the processing proceeds to step S26, and when the selected output word is not the end tag, the processing returns to step S13.

(S26) The model generation unit 124 calculates the average of the errors calculated in step S24 between the start tag and the end tag. The model generation unit 124 updates the values of the parameters of the model based on a condition of minimizing the average error. Note that the model generation unit 124 may repeat steps S10 to S26 using the same or different input texts.

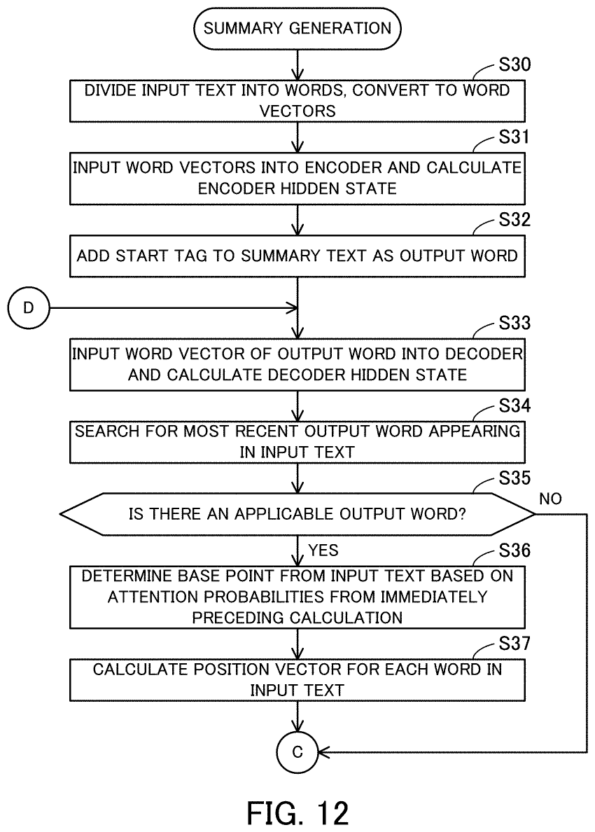

FIG. 12 is a flowchart depicting an example procedure for summary generation. (S30) The summary generation unit 125 divides the input text into a plurality of words. The summary generation unit 125 converts each word produced by the division into a distributed representation word vector xᵢ using a trained word model.

(S31) The summary generation unit 125 inputs the word vector xᵢ into the encoder 133 to calculate the encoder hidden state hᵢ of each word.

(S32) The summary generation unit 125 adds a start tag to the summary text. The summary generation unit 125 selects the start tag as the immediately preceding output word.

(S33) The summary generation unit 125 uses a trained word model to convert the currently selected output word into a distributed representation word vector xₜ. The summary generation unit 125 inputs the word vector xₜ into the decoder 134 to calculate the decoder hidden state sₜ.

(S34) The summary generation unit 125 searches the input text for the most recent output word appearing out of the output words included in the summary text. The most recent output word is the currently selected output word or an earlier output word. When there are at least two output words in the input text, the summary generation unit 125 gives priority to the latter output word.

(S35) The summary generation unit 125 determines whether there is an output word that meets the search condition of step S34 in the summary text. When there is an applicable output word, the processing proceeds to step S36, and when there is no applicable output word, the processing proceeds to step S38.

(S36) The summary generation unit 125 determines a base point from the input text based on the attention probabilities a^{t}ᵢ from the immediately preceding calculation. In more detail, the summary generation unit 125 specifies positions where an output word that meets the search condition of step S34 appears. When an applicable output word appears at only one position, the summary generation unit 125 determines that position as the base point. On the other hand, when the applicable output word appears at two or more locations, the summary generation unit 125 determines the position of the word with the highest attention probability a^{t}ᵢ in the immediately previous calculation as the base point.

(S37) The summary generation unit 125 calculates an index representing the positional relationship with the base point of step S36 for each word included in the input text. The summary generation unit 125 uses a trained numerical model to convert the indices into a distributed representation position vector eₚ.

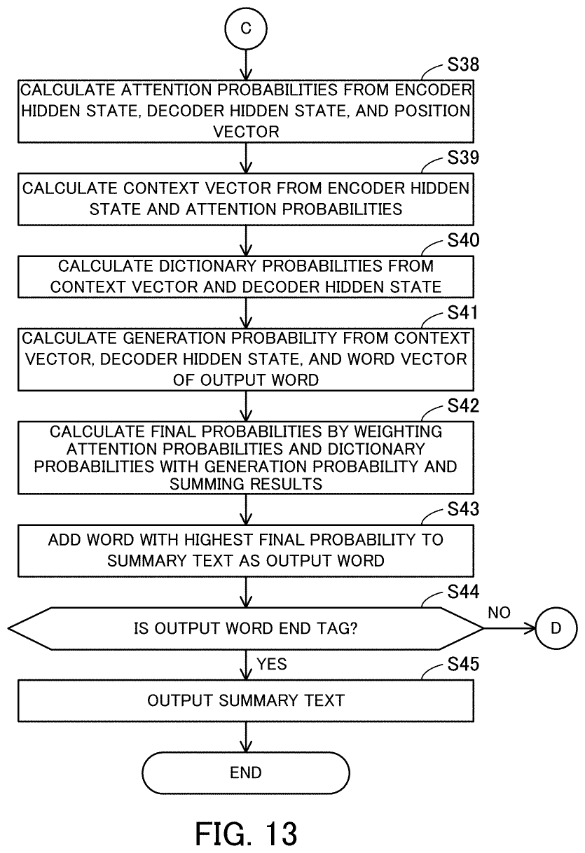

FIG. 13 is (part two of) a flowchart depicting an example procedure for summary generation. (S38) The summary generation unit 125 uses the encoder hidden state hᵢ, the decoder hidden state sₜ, and the position vector eₚ to calculate the attention probability a^{t}ᵢ of each word in the input text.

(S39) The summary generation unit 125 weights and sums the encoder hidden states hᵢ of the plurality of words included in the input text using the attention probabilities a^{t}ᵢ calculated in step S38 to calculate the context vector h*ₜ.

(S40) The summary generation unit 125 calculates the dictionary probability P_{vocab} of each word included in the dictionary data from the context vector h*ₜ and the decoder hidden state sₜ.

(S41) The summary generation unit 125 calculates the generation probability p_{gen} from the context vector h*t, the decoder hidden state sₜ, and the word vector xₜ of the currently selected output word.

(S42) The summary generation unit 125 weights the attention probability a^{t}ᵢ of the words included in the input text and the dictionary probability P_{vocab} of the words included in the dictionary data using the generation probability p_{gen} calculated in step S41, and sums the results to calculate the final probability P of each word.

(S43) The summary generation unit 125 extracts the word with the highest final probability P calculated in step S42 from the word set. The word set is a set produced by combining words included in the input text and words included in the dictionary data. The summary generation unit 125 adds the extracted word to the end of the summary text and selects the word as the immediately preceding output word.

(S44) The summary generation unit 125 determines whether the output word selected in step S43 is the end tag. When the selected output word is the end tag, the processing proceeds to step S45, and when the selected output word is not the end tag, the processing returns to step S33.

(S45) The summary generation unit 125 outputs the generated summary text. As one example, the summary generation unit 125 stores the generated summary text in the text storage unit 121. The summary generation unit 125 also displays the generated summary text on the display apparatus 111.

According to the second embodiment, the machine learning apparatus 100 automatically generates a summary text from an input text. Accordingly, it is possible to use the second embodiment in a variety of applications, such as summarizing a long newspaper article and converting it to a broadcast manuscript to be read out. The machine learning apparatus 100 also generates a summary generation model by machine learning from samples of input texts and summary texts. A neural network is used as the summary generation model. Accordingly, the accuracy of conversion from an input text to a summary text is improved.

The summary generation model also calculates the decoder hidden state from the previous output word and uses the decoder hidden state to calculate the selection probability of each word. Accordingly, a word with strong semantic relevance for the previous output word becomes more likely to be selected as the next output word, which means a natural summary text is generated. The summary generation model calculates attention probabilities of words included in the input text, calculates the dictionary probabilities of words listed in a dictionary, and combines the attention probabilities and the dictionary probabilities to calculate the final probability. Accordingly, the summary generation model is capable of generating a summary text in which balanced use is made of both words that are not included in the input text but are listed in the dictionary and unknown words that are not listed in the dictionary but are included in the input text.

In addition, the summary generation model modifies the attention probabilities of the words included in the input text based on the positional relationship with the word that was most recently copied from the input text into the summary text. Accordingly, the selection probability of words that are positionally close to the word that was most recently copied increases. This means that the summary generation model is able to reduce the risk of a summary text being generated by unnaturally gathering words at distant positions in the input text. As a result, the summary generation model is able to reduce the risk of a summary text including false information that is not present in the input text being generated.

According to one aspect, the present embodiments are able to suppress changes in meaning when generating new text from a given text.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
receiving a first text;
specifying a first position in the first text of a word that is identical to a first word whose use in a second text to be generated based on the first text has been determined;
selecting a second word from a plurality of words included in the first text based on positional relationships between each of the plurality of words and the first position; and
generating the second text including the second word.

2. The non-transitory computer-readable recording medium according to claim 1,
wherein the selecting includes a process of selecting the second word based on selection probabilities of words included in a word set listed in a dictionary and selection probabilities of respective words in the plurality of words that have been calculated in keeping with the positional relationships.

3. The non-transitory computer-readable recording medium according to claim 1,
wherein the second text is a summary of the first text.

4. The non-transitory computer-readable recording medium according to claim 1,
wherein the selecting includes a process of calculating position vectors for each of the plurality of words based on distances between each of the plurality of words and the first position, and modifying, using the position vectors, selection probabilities that are calculated for each of the plurality of words from the plurality of words and the first word.

5. The non-transitory computer-readable recording medium according to claim 1,
wherein the selecting includes a process of lowering respective selection probabilities of the plurality of words in keeping with a distance from the first position.

6. The non-transitory computer-readable recording medium according to claim 1,
wherein the selecting includes a process of specifying, when at least two words that are identical to the first word are present in the first text, a position of a word with a highest selection probability calculated when the first word was selected out of the at least two identical words as the first position.

7. A text generation apparatus comprising:
a memory configured to store a first text; and
a processor coupled to the memory and the processor configured to:
specify a first position in the first text of a word that is identical to a first word whose use in a second text to be generated based on the first text has been determined;
select a second word from a plurality of words included in the first text based on positional relationships between each of the plurality of words and the first position; and
generate the second text including the second word.

8. A machine learning method comprising:
receiving, by a processor, a first text and a second text that corresponds to the first text;
specifying, by the processor, a first position in the first text of a word that is identical to a first word included in the second text;
calculating, by the processor, a selection probability of selecting a second word included in the second text out of a plurality of words included in the first text, based on positional relationships between each of the plurality of words and the first position; and
generating a model capable of generating the second text from the first text based on the selection probability.
